(19) United States
(12) Patent Application Publication
(10) Pub. No.: US 2011/0026480 A1
(43) Pub. Date: Feb. 3, 2011

(54) HIERARCHICAL TRANSMISSION SYSTEM AND METHOD FOR VARIABLE QUALITY SERVICE ON CELLULAR SYSTEM

(75) Inventors: Jae Heung Kim, Daejeon (KR); Kyoung Seok Lee, Daejeon (KR)

Correspondence Address: NELSON MULLINS RILEY & SCARBOROUGH LLP;FLOOR 30, SUITE 3000, ONE POST OFFICE SQUARE, BOSTON, MA, 02109, US

(73) Assignee: ELECTRONICS AND TELECOMMUNICATIONS RESEARCH INSTITUTE, DAEJEON (KR)

(21) Appl. No.: 12/934,715

(22) PCT Filed: Mar. 30, 2009
(86) PCT No.: PCT/KR2009/001590

§ 371 Date: Sep. 27, 2010

(30) Foreign Application Priority Data
Mar. 28, 2008 (KR) 10-2008-0028855
Mar. 26, 2009 (KR) 10-2009-0025747

(51) Int. Cl. H04W 28/24

(52) U.S. Cl. 370/329

(57) ABSTRACT

The present invention relates to a hierarchical transmission apparatus and method for a variable QoS, which may hierarchically transmit packet information using an available scheme and resource between a terminal and a base station, thereby supporting various QoSs in a cellular system. The hierarchical transmission method includes generating packet information, hierarchically encoding the packet information in accordance with a control parameter to generate a plurality of hierarchical packets, adapting a Multiple Input Multiple Output (MIMO) technique to the plurality of hierarchical packets to generate hierarchical packet information, and including a plurality of antennas to transmit the hierarchical packet information for each of the plurality of antennas.

### TECHNICAL FIELD

The present invention relates to a hierarchical transmission apparatus and method for a variable Quality of Service (QoS) in a cellular device, and more particularly, to a hierarchical transmission apparatus and method for a variable QoS, which may hierarchically transmit packet information using an available scheme and resource between a terminal and a base station, thereby supporting various QoSs in a cellular system.

### BACKGROUND ART

In a conventional cellular system, an arbitrary service has been controlled to maintain a uniform quality in accordance with a Quality of Service (QoS) management scheme set in the conventional cellular system.

However, frequency assignment between countries and territories and bandwidths of systems provided by existing operators may differ from each other, and with the development of a base station or terminal introducing a Multi Input Multi Output (MIMO) antenna technique, an environment for providing a packet service has been diversely attempted to improve a throughput depending on service situations.

However, this may create problems in that despite a service maintaining a uniform quality in a specific environment, the service may provide a quality less than the uniform quality in different environments, or a poor quality having a difficulty in being operated in a corresponding environment.

Accordingly, there arises a need for an apparatus and method of supporting various throughputs and QoSs in accordance with a peripheral environment condition transmitting information.

### DISCLOSURE OF INVENTION

### Technical Goals

An aspect of the present invention provides a hierarchical transmission apparatus and a filtering method to support the packet service with variable Quality of Service (QoS), which may hierarchically transmit packet information in a packet-based cellular system to support and provide various QoSs being suitable for a User Equipment (UE) capability of a base station or a terminal, thereby improving the system performance with variable QoS.

### Technical Solutions

According to an aspect of the present invention, there is provided a hierarchical transmission method to support the service with variable Quality of Service (QoS), the method comprising: generating packet information; hierarchically encoding the packet information in accordance with a control parameter to generate a plurality of hierarchical packet information; adapting a Multiple Input Multiple Output (MIMO) technique to the plurality of hierarchical packets to generate hierarchical packet information; and including a plurality of antennas to transmit the hierarchical packet information for each of the plurality of antennas.

According to an aspect of the present invention, there is provided a hierarchical transmission apparatus to support the packet service with variable QoS, which aggregates a plurality of fragmented frequency bands to support a frequency band with a bandwidth greater than that of the plurality of fragmented frequency bands, the method apparatus comprising: generating packet information; hierarchically encoding the packet information in accordance with a control parameter to generate a plurality of hierarchical packets; and transmitting the plurality of hierarchical packets using the plurality of fragmented frequency bands.

According to an aspect of the present invention, there is provided a hierarchical transmission apparatus for a variable QoS and having a radio resource with a two-dimensional structure, the radio resource being differentiated by a frequency and time, and the apparatus including: a generation unit to generate packet information; a hierarchical encoding unit to hierarchically encode the packet information in accordance with a control parameter to generate a plurality of hierarchical packets; and a transmission unit to allocate the plurality of hierarchical packets to different sub carriers on a frequency axis.

According to an aspect of the present invention, there is provided a hierarchical transmission apparatus to support the packet service with variable QoS, the apparatus including: a generation unit to generate packet information; a hierarchical encoding unit to hierarchically encode the packet information in accordance with a control parameter to generate a plurality of hierarchical packets; and a transmission unit to transmit the plurality of hierarchical packets. In this instance, the transmission unit may be located in a plurality of nodes or cells, each being different from each other, from among base stations or cells, that is, network nodes of the cellular system.

### ADVANTAGEOUS EFFECTS

According to the present invention, there are provided a hierarchical transmission apparatus and method to support the packet service with variable Quality of Service (QoS), which may hierarchically transmit packet information in a packet-based cellular system, so that the apparatus and method are adapted in accordance with capability of a base station or a user terminal to transmit and receive a packet, thereby improving the system performance with variable QoSs.

### BRIEF DESCRIPTION OF DRAWINGS

FIG. 1 is a schematic diagram illustrating a hierarchical transmission apparatus to support the packet service with variable Quality of Service (QoS) according to example embodiments of the present invention;

FIG. 2 illustrates an example of configurations of a base station and a terminal in a system hierarchically transmitting a packet in a Multi input Multi Output (MIMO) scheme;

FIG. 3 illustrates an example of configurations of a base station and a terminal in a Long Term Evolution (LTE) system;

FIG. 4 illustrates an example of a bandwidth for each base station of a LTE system;

FIG. 5 illustrates an example of hierarchically transmitting a hierarchical packet using a division frequency;

FIG. 6 illustrates an example of distributing a hierarchical packet in a frequency domain and transmitting the distributed packet in a system transmitting the hierarchical packet in an Orthogonal Frequency Division Multiple Access (OFDMA) scheme;

FIG. 7 illustrates an example of distributing a hierarchical packet in a time domain and transmitting the distributed packet in a system transmitting the hierarchical packet in an OFDMA scheme; and

FIG. 8 is a flowchart illustrating a hierarchical transmission method for a variable QoS according to example embodiments of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

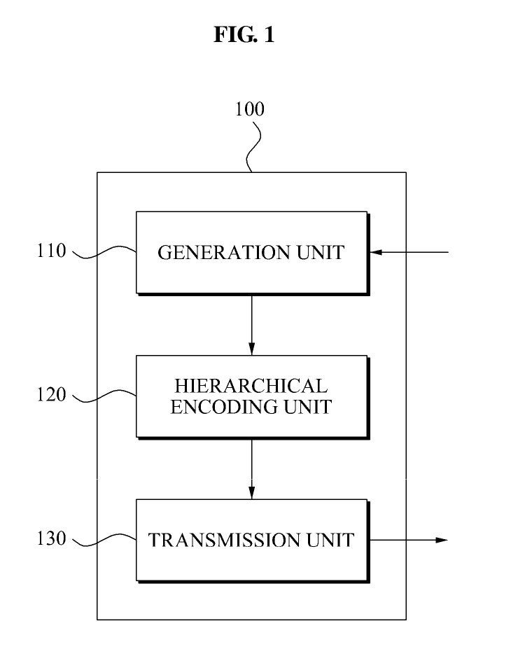

FIG. 1 is a schematic diagram illustrating a hierarchical transmission apparatus 100 to support the packet service with variable Quality of Service (QoS) according to example embodiments of the present invention.

The apparatus 100 according to the present example embodiment which may transmit information to a terminal in a cellular system includes, as illustrated in FIG. 1, a generation unit 110, a hierarchical encoding unit 120, and a transmission unit 130. The apparatus 100 may be logically configured of a base station or cell, which transmit generated packet information to a terminal within a certain service area, or logically configured of a plurality of base stations or a base station together with an upper node.

In this instance, the upper node may be a Gate Way (GW).

The generation unit 110 may generate packet information intending to be transmitted to a terminal from an application layer or an upper layer.

The hierarchical encoding unit 120 may hierarchically encode the packet information in accordance with a control parameter to generate a plurality of hierarchical packets. In this instance, the hierarchical encoding unit 120 may classify the packet information into a based packet stream and an enhanced or advanced packet stream to encode the classified packet information.

The control parameter includes at least one piece of information about a type of the packet information, an operation condition of a base station transmitting the plurality of hierarchical packets, an operation condition of a terminal receiving the hierarchical packet information, an operation state of the terminal, and a type of the terminal.

The information about the type of the packet information may include at least one of service type information provided by the packet information, transmission interval information of the packet information, and required QoS information provided by the packet information.

In this instance, the service type information provided by the packet information may be information about a packet providing broadcasting services such as Multimedia Broadcast Multicast Service (MBMS), Multicast service, or broadcast service, or information about a packet providing uni-cast services such as video telephony services, games.

Also, the transmission interval information of the packet information may be any one piece of information about a Transmission Time Interval (TTI), a frame for hierarchical encoding, a resource assignment interval such as scheduling, and a transmission setting interval, and the required QoS information provided by the packet information may be information about parameters of a Receive Signal Strength Indicator (RSSI), a reception Signal-to-Noise Ratio (SNR), Signal-to-Interference and Noise Ratio (SINR), Eb/No, a bit error rate (BER), a block error rate (BLER), and a packet error rate (PER), or a required resolution or minimum resolution based on a capability of a display apparatus.

The information about the operation condition of the base station and terminal may include at least one of system bandwidth information, applied antenna technique information, base station environment information, and concurrent reception capacity information of the terminal.

In this instance, the system bandwidth information may include information about a center frequency or bandwidth information of the base station or terminal, and the applied antenna technique information may include information about a number of antennas of the base station and terminal, or information about whether a Multiple Input Multiple Output (MIMO) technique or a diversity technique is applied to the base station and the terminal. The base station environment information may include information about base station setting parameters in a hierarchical cell structure that is configured of a dedicated base station for arbitrary services of a corresponding base station or cell, and a normal base station, and also may include information about the MBMS.

The information about the operation condition of the terminal may include information about whether the terminal is in a connected/active state or in an idle state, and also include a type of services provided in the connected state.

The information about the type of the terminal may include information about which one the terminal is from among a general cellular phone, a Personal Digital Assistant (PDA), a notebook Personal Computer (PC), a compound terminal, and the like, and information about a screen displaying method, a size, and a resolution of a display apparatus of the terminal.

The information for the MBMS may be information that is transmitted by the dedicated base station or normal base station for the purpose of MBMS support, and may include at least one of MBMS notification information, MBMS indication information, MBMS Single Frequency Network (MBSFN) configuration information, and MBMS Control Channel (MCCH) configuration information. To support MBMS services, a corresponding base station or cell may transmit, to terminals, information indicating whether the corresponding base station and cell is a dedicated base station or cell only providing the MBMS, or a base station or cell providing the MBMS together with the uni-cast service.

Here, the MBMS notification information is information indicating whether to support the MBMS, and the MBMS indication information is information including control information and indicating when the MBMS service is transmitted, and the MBSFN configuration information may be information including an MBSFN identifier, an MBSFN frame, a sub-frame configuration/assignment information, and the like. Also, the MCCH configuration information may be configured of a primary MCCH or/and a secondary MCCH, and include information about an MBMS service identifier, an MBMS session identifier, an MBMS resource assignment information, and the like.

Specifically, the hierarchical encoding unit 120 may generate hierarchical information corresponding to each condition in accordance with the control parameter including information about the base station transmitting a packet and the terminal receiving the packet, and information about the packet, thereby generate the hierarchical information being suitable for other conditions.

The transmission unit 130 may transmit, to the terminal, the hierarchical information generated by the hierarchical encoding unit 120 in accordance with characteristics and structure of a system including the base station.

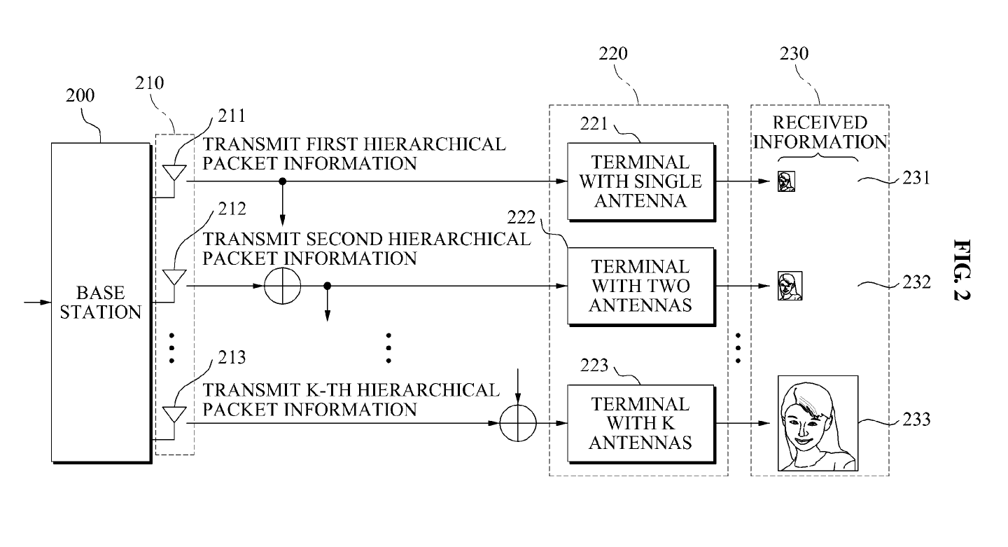

In this instance, the hierarchical encoding unit 120 and the transmission unit 130 may perform specific operations in accordance with a system including the base station and the terminal, a system including the base station, or a system including the terminal, and examples in which the hierarchical encoding unit 120 and the transmission unit 130 are applied in various systems will be described in detail with reference to FIGS. 2 to 6.

FIG. 2 illustrates an example of configurations of a base station and a terminal in a system hierarchically transmitting a packet in a Multi input Multi Output (MIMO) scheme.

The hierarchical encoding unit 120 included in the base station 200 may hierarchically encodes packet information in accordance with a control parameter to generate a plurality of hierarchical packets, and adapt a MIMO technique to the plurality of hierarchical packets to generate hierarchical packet information. In this instance, the MIMO technique may divide the plurality of hierarchical packets in a layer 2 in accordance with a predetermined layer number to delivery the divided hierarchical packets to a physical layer, and may perform a physical layer procedure including a pre-coding in accordance with a predetermined code book to thereby generate the hierarchical packet information during transport channel processing.

Also, the transmission unit 210 may include a plurality of antennas 211, 212, and 213 to correspond to characteristics of a MIMO scheme transmitting a packet using the plurality of antennas, and transmit the hierarchical packet information, which is generated by the hierarchical encoding unit 120, on each of the plurality of antennas. In this instance, the layer 2 may divide the hierarchical packet as the same number as a number ‘K’ of the plurality of antennas included in the transmission unit 130.

In this instance, an amount of the hierarchical packet information received at a terminal 220 may vary depending on a number of the antennas included in the terminal 220.

As an example, a terminal 221 including a single antenna may receive only first layer packet information transmitted in the antenna 221 to restore only reception information 231 included in the first layer packet information.

Conversely, a terminal 222 including two antennas may receive the transmitted first layer packet information and second layer packet information transmitted in the antenna 212 to restore reception information 232 including information more than those of the reception information 231.

Also, a terminal 223 including K antennas being identical to the number of antennas of the base station may receive all packet information ranging from the first layer packet information transmitted in the antenna 211 to K-th layer packet information transmitted in the antenna 213 to restore reception information 233 being identical to information received at the base station 200.

Also, in a case of transmitting packet information being hierarchically encoded in the MIMO scheme, a one-to-one mapping relation between the plurality of antennas and the hierarchically encoded streams may not be adapted, and a general MIMO technique in which the hierarchically encoded streams are transmitted alternately using the plurality of antennas, thereby increasing a transmission speed. Also, a scheme obtaining only a diversity gain using the plurality of antennas may be adapted.

In this instance, a multimedia broadcasting such as the MBMS and multi-cast services may be required to be provided even in an idle state where the terminal does not have any connection for information exchange with the base station, and an open loop MIMO technique that does not need feedback information by transmitting the packet for the terminals being in the idle state may be adapted.

However, a closed loop MIMO technique that transmits feedback information using terminals being in the connected state as necessary, and change a transmission parameter based on the transmitted feedback information may be additionally adapted.

Also, the control information used for transmitting the hierarchical packet information may be transmitted for each layer together with the hierarchical packet information, or may configure a separate control channel. Also, a mapping relation between each of the hierarchical packet information and the plurality of antennas of the base station and terminal may be a symmetry configuration or asymmetry configuration as being set in a system.

Specifically, the hierarchical transmission apparatus 100 for the variable QoS in a system of hierarchically transmitting using the MIMO scheme may adapt a hierarchical encoding scheme to transmit the packet information. As a result, uni-cast services such as games or video telephony services requiring a high quality may be differentiated in accordance with various wireless channel environments between the base station 200 and the terminal 220 and a User Equipment class or a User Equipment capability (including a displaying scheme, a size, a resolution/sharpness, and the like) of the terminals 220 to provide the differentiated uni-cast services or video telephony services, thereby restoring information provided by the uni-cast services into reception information 230 having a level being suitable for the configuration of terminal.

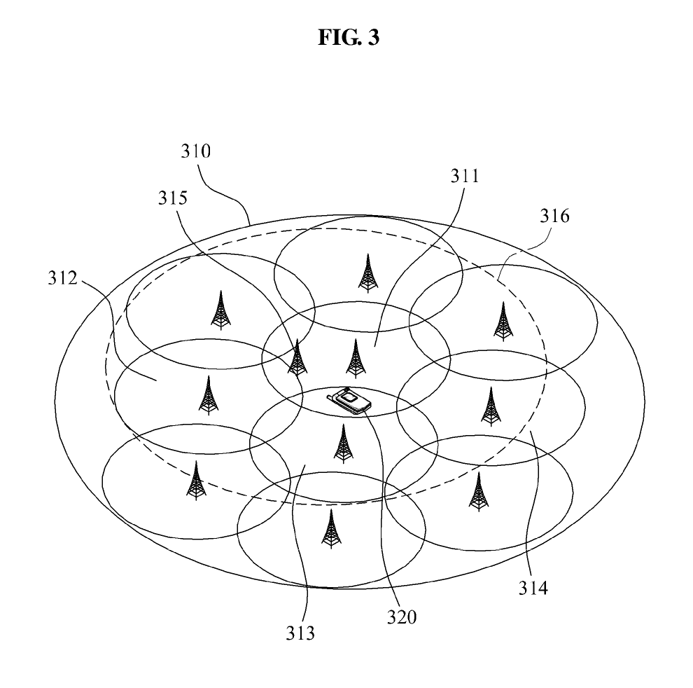

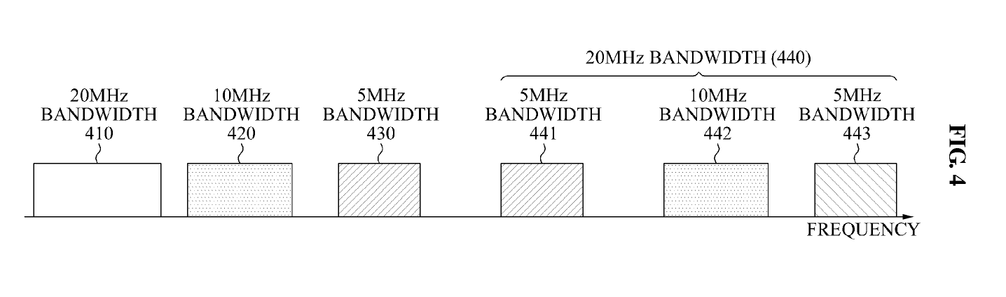

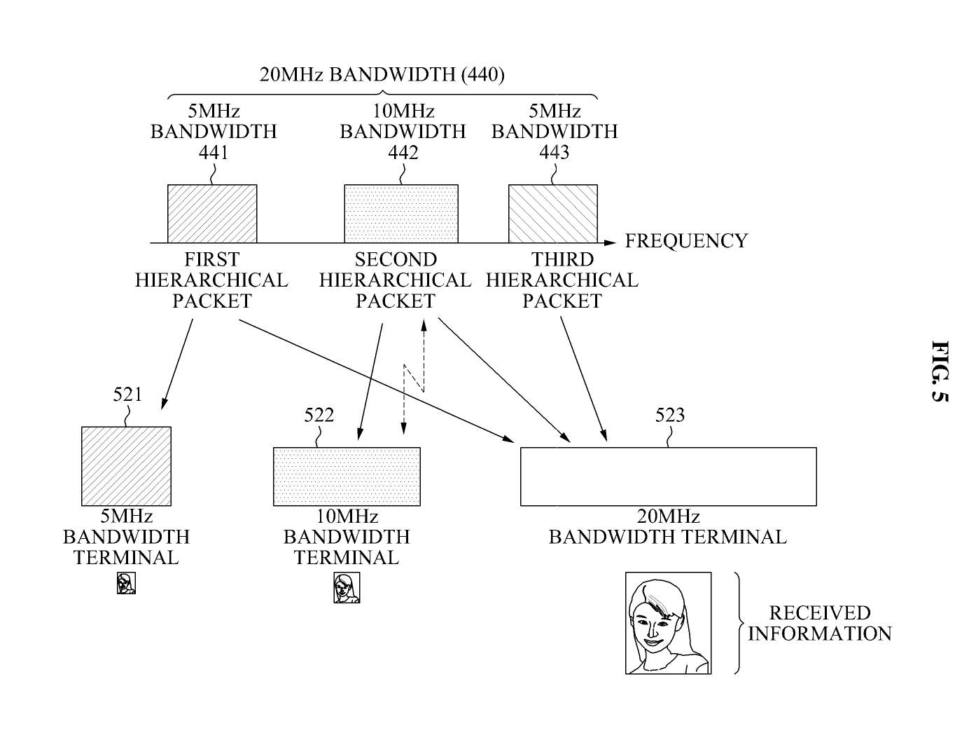

FIG. 3 illustrates an example of configurations of a base station and a terminal in a Long Term Evolution (LTE) system, FIG. 4 illustrates an example of a bandwidth for each base station of a LTE system, and FIG. 5 illustrates an example of hierarchically transmitting a hierarchical packet using a fragmented frequency band. In the LET system, a cell operating a dedicated carrier for only MBMS services and a mixed cell providing the MBMS services and the uni-cast services in a single cell may be assumed for the MBMS. Also, to overcome performance deterioration in a wireless environment such as interferences in a cell boundary and effectively provide the MBMS service, an MBSFN scheme in which plurality of cells provide services in a larger region may be introduced.

Accordingly, terminals may receive, from the plurality of cells, packet information for the MBMS service within an MBSFN service area, thereby enabling continuous service reception even in a poor radio channel environment.

As illustrated in FIG. 3, to overcome performance deterioration in the wireless environment such as interferences in region boundaries of a plurality of base stations 311, 312, 313, and 314, and effectively providing the MBMS services, the MBSFN scheme in which the plurality of base stations 311, 312, 313, and 314 provide services in a larger service area may be adapted.

Accordingly, terminals 320 may receive, from the plurality of base stations 311, 312, 313, and 314, the packet information for the MBMS services within an overall MBSFN region 310, thereby enabling continuous service reception even in a poor radio channel environment. As an example, as illustrated in FIG. 3, the terminal 320 may receive, from the plurality of base stations 311, 312, 313, and 314, the packet information to gain a diversity gain, thereby increasing reception performance.

Also, by adapting a hierarchical cell structure using an MBMS dedicated base station and a normal base station of a mixed cell type, the MBMS services may be provided using the MBMS dedicated base station covering the service area of the plurality of base station within MBSFN service area or the overall MBSFN service area 310 in a case of the MBSFN scheme. In this case, MBMS packet streams may be hierarchically encoded using the MBMS dedicated base station and the normal base station, and transmitted. Specifically, the hierarchically encoded MBMS packet streams may be separately or alternatively transmitted by the MBMS dedicated base station and the normal base station.

For example, the MBMS dedicated base station may transmit a based packet stream for the MBMS, and the normal base station may transmit an enhanced or advanced packet stream, and vice versa. Accordingly, the terminal 320 within the MBSFN service area may receive, from a dedicated base station 315 covering a part 316 of the MBSFN region or the overall MBSFN region 310 or or a connected or camping normal base station, the hierarchically encoded MBMS packet streams, and may be provided with services having a quality being optimized for a terminal environment.

In a case of providing the MBMS services in this hierarchical cell structure, following scenarios will be possible.

As an example, the MBMS dedicated base station 315 and another MBMS dedicated base station may configure a single MBSFN region 316, and the plurality of base stations 311, 312, 313, and 314 configuring another layer may configure the another MBSFN region 310 to thereby support the MBMS services.

Also, as another example, the MBSFN region 310 configured by only the MBMS dedicated base stations and the plurality of base stations 311, 312, 313, and 314 of another layer may not provide the MBMS services, and may provide only the uni-cast services.

The MBMS dedicated base station or the normal base station providing the MBMS services may not configure the MBSFN, and support the MBMS services by means of transmission of a single base station.

In this instance, a base station or cell in different MBMS service regions or in the MBSFN region may provide information for the MBMS with respect to a region of the base station or cell, and information for the MBMS with respect to an neighbor MBMS region or the neighbor MBSFN region.

As an example, even in a case where the MBSFN region 310 configured only by the MBMS dedicated base stations and the plurality of base stations 311, 312, 313, and 314 of the other layer do not provide the MBMS service and provide only the uni-cast services, the normal base stations not providing the MBMS services may configure the MBSFN region, or provide the information for the MBMS provided by the MBMS dedicated base station not configuring the MBSFN region using system information or a separate common/dedicated control channel.

The information for the MBMS may be information transmitted for the MBMS support in the dedicated base station or the normal base station, and may include at least one of MBMS notification information, MBMS indication information, MBSFN configuration information, and MCCH configuration information. Also, the information for the MBMS may include a piece of information indicating whether a corresponding base station or cell for the MBMS service support is the dedicated bases station or cell providing only the MBMS service, or a base station or cell providing the MBMS service together with the uni-cast services. Also, the LTE system may be designed based on various system bandwidths so as to support bandwidth scalability in response to operator's requests, support a system bandwidth such as 1.25, 2.5, 5, 10, 20 MHz and the like, and aggregate fragmented frequency bands to support a larger system bandwidth.

Accordingly, as for the LTE system, a base station having a 20 MHz bandwidth 410, 10 MHz bandwidth 420, or a 5 MHz bandwidth 430 may exist, and a base station that aggregates fragmented frequency bands of a 5 MHz bandwidth 441, a 10 MHz bandwidth 442, and a 5 MHz bandwidth 443 to support a 20 MHz bandwidth 440 may exist. In this instance, a terminal supporting various system bandwidths may exist in accordance with a class or UE capability of the terminal.

In the hierarchical transmission method for the variable QoS in the LET system, the base station having the 20 MHz bandwidth 410, the 10 MHz bandwidth 420, or the 5 MHz bandwidth 430 may transmit a hierarchical packet having each of the 20 MHz bandwidth 410, the 10 MHz bandwidth 420, or the 5 MHz bandwidth 430.

Also, the base station supporting the 20 MHz bandwidth 440 may transmit a hierarchical packet using the fragmented frequency bands of the 5 MHz bandwidth 441, the 10 MHz bandwidth 442, or the 5 MHz bandwidth 443, and terminals 521, 522, and 523 within a region of the base station may receive packets being differentiated in accordance with a bandwidth of each of terminals. As an example, the terminal 521 with 5 MHz bandwidth may receive a first hierarchical packet transmitted using the 5 MHz bandwidth 441, the terminal with 10 MHz bandwidth may receive a second hierarchical packet transmitted using the 10 MHz bandwidth 442, and the terminal 523 with 20 MHz bandwidth may receive the first hierarchical packet, the second hierarchical packet, and a third hierarchical packet transmitted using the 5 MHz bandwidth 443 to thereby restore the received packets. The base stations with different bandwidths may be operated in any one type of the hierarchical cell environment, the dedicated base station, and the normal base station in accordance with a configuration of a network.

Also, control information for packet transmission where the hierarchical encoding method is applicable may be transmitted for each band, or may configure a separate control channel.

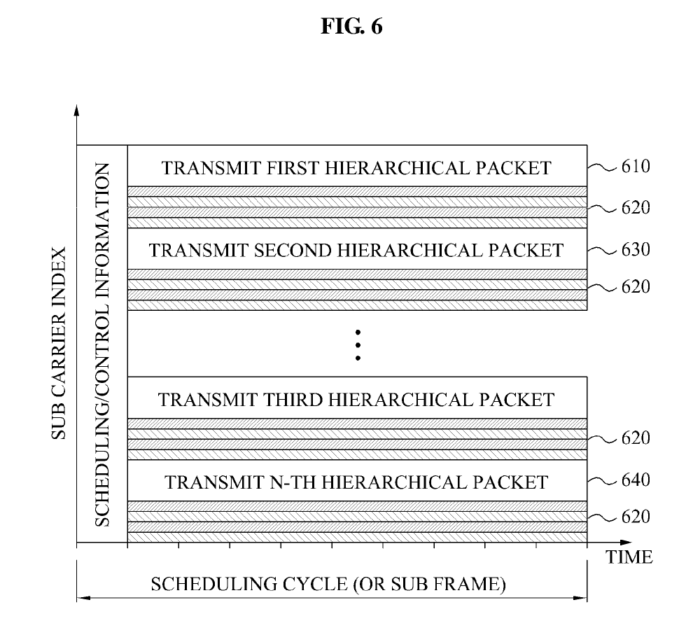

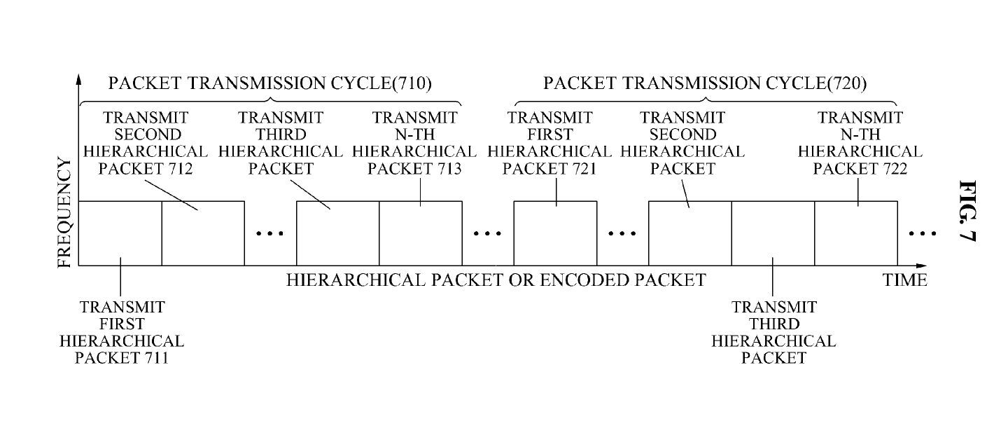

FIG. 6 illustrates an example of distributing a hierarchical packet in a frequency domain and transmitting the distributed packet in a system transmitting the hierarchical packet in an Orthogonal Frequency Division Multiple Access (OFDMA) scheme, and FIG. 7 illustrates an example of distributing a hierarchical packet in a time domain and transmitting the distributed packet in a system transmitting the hierarchical packet in an OFDMA scheme.

The system of the OFDMA scheme may be a system having a radio resource with a two-dimensional structure, which is differentiated by a frequency and time, and downlink and uplink physical channels of the system of the OFDMA scheme may separately transmit the radio resource configured of the time and frequency, and a radio resource of the system of the OFDMA scheme may use a radio resource block that is divided into the TTI of a transmission interval and a sub carrier group.

In this instance, the base station may assign, as illustrated in FIG. 6, a first hierarchical packet 610, a second hierarchical packet 630, and an N-th hierarchical packet 640 to sub carriers sequential with each other on a frequency axis and transmit the assigned packets, or may assign the above-mentioned hierarchical packets to distributed sub carries 620 and transmit packet information being encoded in a multi-layered method.

Also, the base station may transmit, as illustrated in FIG. 7, hierarchical packets 711, 712, 713, 721, and 722 being hierarchically encoded using different transmission times on a time axis.

In this instance, separate packet transmission intervals 710 and 720 that group N hierarchical packets into a single section and transmitting the grouped hierarchical packets may be set.

Multi-encoded packets may be transmitted using a separate sub carrier and an arbitrary time based on the frequency and time, and the transmitted packets are distributed on both the frequency axis and the time axis.

Accordingly, terminals may selectively receive N hierarchical packets being hierarchically encoded in accordance with an operation condition of the base station, a radio channel environment, an operation state or connection state of the terminal, and a type of provided services, and may be provided with differentiated services.

In this instance, control information for transmission of the hierarchical packet may be transmitted together with each hierarchical packet when transmitting each hierarchical packet, and may enable the control information to be included in a separate control channel, a predetermined hierarchical/multiple encoded transmission parameter, etc.

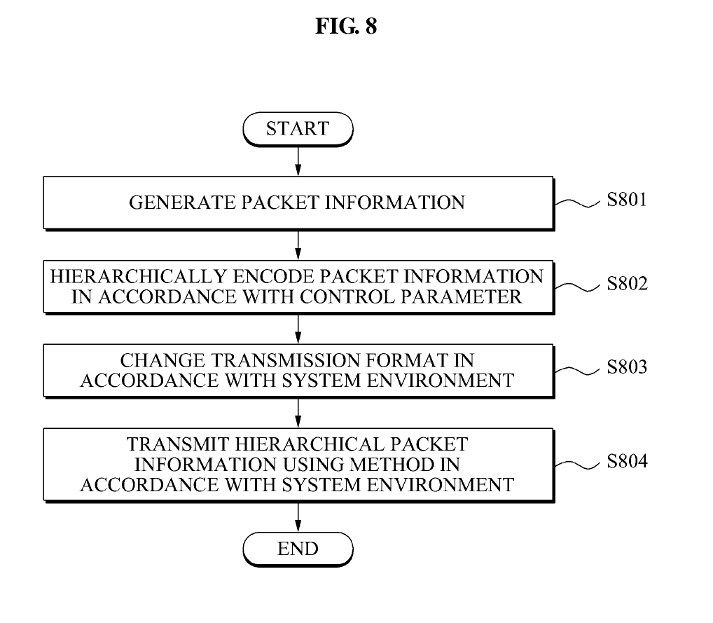

FIG. 8 is a flowchart illustrating a hierarchical transmission method for a variable QoS according to example embodiments of the present invention.

In operation S801, the generation unit 110 may generate packet information intending to be transmitted from a sender to a terminal.

In operation S802, the hierarchical encoding unit 120 may hierarchically encode the generated packet information in accordance with a control parameter to generate a plurality of hierarchical packets.

In this instance, the hierarchical encoding unit 120 may generate hierarchical information corresponding to each condition in accordance with a base station transmitting a packet, the terminal receiving the packet, and the control parameter including information about the packet to thereby generate the hierarchical information being suitable for different conditions.

In operation S803, the hierarchical encoding unit 120 may change a transmission format of the hierarchical packets generated in operation S802 in accordance with a system environment where the hierarchical transmission method for the variable QoS is applicable.

As an example, when the system where the hierarchical transmission method for the variable QoS is applicable is an MIMO system, the hierarchical packet information may be generated by adapting the MIMO technique to the hierarchical packet.

Also, in operation S803, the transmission format of the hierarchical packet may not be changed in accordance with the system environment where the hierarchical transmission method for the variable QoS is applicable.

In operation S804, the transmission unit 130 may transmit, to the terminal, the hierarchical packets whose transmission packet is determined in operation S803 in a method of the system environment where the hierarchical transmission method for the variable QoS is applicable.

As an example, when the system where the hierarchical transmission method for the variable QoS is applicable is the MIMO system, the hierarchical packet information generated in operation S803 may be transmitted for each antenna.

Also, when the system where the hierarchical transmission method for the variable QoS is applicable is a cellular system where a dedicated cell and normal base station for a hierarchical cell environment or specific services exist, the hierarchical packets generated in operation S802 may be transmitted via hierarchical environment cells, dedicated cells, or normal base stations, and may be hierarchically encoded using the control parameter in each base station in accordance with a configuration of the apparatus 100 to thereby be transmitted.

Also, when the system where the hierarchical transmission method for the variable QoS is applicable is the LTE system, the hierarchical packets generated in operation S802 may be transmitted using each of fragmented frequency bands.

Also, when the system where the hierarchical transmission method for the variable QoS is applicable is a system using the OFDMA scheme, the hierarchical packets generated in operation S802 may be distributed based on a frequency axis and a time axis to thereby be transmitted.

The above described hierarchical transmission apparatus and method for the variable QoS may be operated using a multiple layer packet generated using a multiple layer encoding method instead of using a hierarchy encoding method.

As described above, according to the hierarchical transmission apparatus and method for the variable QoS, the hierarchical encoding method or the multiple layered encoding method may be adapted based on information about a system bandwidth of the base station and terminal, a UE capability of the terminal, a size and capacity of a display apparatus of the terminal, and information about whether the MIMO antenna technique is adapted, so that the packet information may be differentiated in accordance with each condition to support and various quality services being suitable for the UE capability of the base station or terminal, thereby increasing a provided service quality.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A hierarchical transmission method for a variable Quality of Service (QoS), the method comprising:
generating packet information;
hierarchically encoding the packet information in accordance with a control parameter to generate a plurality of hierarchical packets;
adapting a Multiple Input Multiple Output (MIMO) technique to the plurality of hierarchical packets to generate hierarchical packet information; and
including a plurality of antennas to transmit the hierarchical packet information for each of the plurality of antennas.

2. The method of claim 1, wherein the control parameter includes at least one piece of information of information about a type of the packet information, a condition of a base station transmitting the plurality of hierarchical packets and a condition of a terminal receiving the hierarchical packet information, an operation state of the terminal, and a type of the terminal.

3. The method of claim 1, wherein the adapting of the MIMO technique adapts an open loop MIMO technique to the plurality of hierarchical packets to generate the hierarchical packet information.

4. The method of claim 2, wherein an amount of the hierarchical packet information received at the terminal varies depending on a number of the plurality of antennas.

5. The method of claim 2, wherein the packet information is information being hierarchically encoded using any one of a hierarchical cell, a dedicated cell, and a normal base station in a system where the hierarchical cell or the dedicated cell for a specific service is employed.

6. A hierarchical transmission apparatus for a variable QoS, which aggregates a plurality of fragmented frequency bands to support a frequency band with a bandwidth greater than that of the plurality of fragmented frequency bands, the method comprising:
generating packet information;
hierarchically encoding the packet information in accordance with a control parameter to generate a plurality of hierarchical packets; and
transmitting the plurality of hierarchical packets using the plurality of fragmented frequency bands.

7. The method of claim 6, wherein the plurality of hierarchical packets are packets in which information received at a terminal receiving the plurality of hierarchical packets is differentiated in accordance with a bandwidth of the terminal.

8. The method of claim 7, wherein when the bandwidth of the terminal is greater than that of the plurality of fragmented frequency bands, the transmitting transmits a plurality of hierarchical information using the plurality of fragmented frequency bands.

9. A hierarchical transmission apparatus for a variable QoS and having a radio resource with a two-dimensional structure, the radio resource being differentiated by a frequency and time, and the apparatus comprising:
a generation unit to generate packet information;
a hierarchical encoding unit to hierarchically encode the packet information in accordance with a control parameter to generate a plurality of hierarchical packets; and
a transmission unit to allocate the plurality of hierarchical packets to different sub carriers on a frequency axis.

10. The apparatus of claim 9, wherein the transmission unit transmits the plurality of hierarchical packets at different times.

11. The apparatus of claim 10, wherein the transmission unit allocates the plurality of hierarchical packets to sub carriers being connected with each other on the frequency axis or sub carriers being distributed on the frequency axis, and transmits the allocated packets.
